(19) United States
(12) Patent Application Publication
(10) Pub. No.: US 2026/0046673 A1
(43) Pub. Date: Feb. 12, 2026

(54) DETERMINING AND ADAPTING WIRELESS NETWORK FUNCTIONALITY USING MULTIPLE CONFIGURATION SETS

(71) Applicant: SHARP KABUSHIKI KAISHA, Sakai City (JP)

(72) Inventors: Rudraksh Shrivastava, Erligheim (DE); Tomoki Yoshimura, Camas, WA (US)

(21) Appl. No.: 18/798,624

(22) Filed: Aug. 8, 2024

(51) Int. Cl. H04W 28/02; H04W 28/16; H04W 72/23; H04W 72/51

(52) U.S. Cl. CPC H04W 28/0215; H04W 28/16; H04W 72/23; H04W 72/51

(57) ABSTRACT

A wireless communication network node is provided. The network node includes one or more non-transitory computer-readable media storing one or more computer-executable instructions for configuring a functionality to a user equipment (UE) and at least one processor. The processor is configured to generate several configuration sets for the functionality of the UE based on one or more capabilities of the UE. The processor is configured to transmit the configuration sets for the functionality to the UE. The processor is configured to determine a change in a condition of the functionality of the UE. The processor is configured to select a first configuration set associated with the condition, for the functionality of the UE. The processor is configured to transmit a message to the UE to use the first configuration set to configure the functionality of the UE based on the first configuration set.

### TECHNICAL FIELD

The technology generally relates to wireless communications, and more particularly, to predictive beam configuration.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to increase, however, there is a need for further improvements in wireless communications in the next-generation radio communication systems.

### SUMMARY

In a first aspect of the present application, a wireless communication network node is provided. The network node includes one or more non-transitory computer-readable media storing one or more computer-executable instructions for configuring a functionality to a user equipment (UE) and at least one processor coupled to the one or more non-transitory computer-readable media. The at least one processor is configured to execute the one or more computer-executable instructions to cause the network node to generate several configuration sets for the functionality of the UE based on one or more capabilities of the UE; transmit the configuration sets for the functionality to the UE; determine a change in a condition of the functionality of the UE; select a first configuration set, which is associated with the condition, for the functionality of the UE; and transmit a message to the UE to use the first configuration set to configure the functionality of the UE based on the first configuration set.

In an implementation of the first aspect, the functionality is an artificial intelligence/machine learning (AI/ML) functionality that the UE is ready to apply for AI/ML model inference or an AI/ML functionality that the UE supports based on the UE capabilities.

In another implementation of the first aspect, the configuration sets include a partial configuration set that includes a subset of parameters of a corresponding full configuration set. The subset of parameters allows the UE to determine whether the functionality corresponding to the configuration set is a functionality that the UE is ready to apply for an AI/ML model. The at least one processor is further configured to execute the one or more computer-executable instructions to cause the network node to receive a message from the UE indicating that the functionality corresponding to the partial configuration set is a functionality that the UE is ready to apply to the AI/ML model; and transmit the full configuration sets corresponding to the partial configuration set to the UE.

In another implementation of the first aspect, the configuration sets include only full configuration sets, only partial configuration sets, or a mix of full and partial configuration sets. A full configuration set includes parameters that allow the UE to perform tasks and reporting for the functionality corresponding to the configuration set. A partial configuration set includes a subset of parameters of a corresponding full configuration set that allows the UE to determine whether the functionality corresponding to the configuration set is a functionality that the UE is ready to apply to an AI/ML model. Configuring a configuration set to the UE enables the UE to perform AI/ML inference.

In another implementation of the first aspect, determining the change in the functionality of the UE includes receiving a message from the UE indicating a change in a UE side of the wireless communication network.

In another implementation of the first aspect, determining the change in the functionality of the UE includes determining a change, by the network node, in a network node side of the wireless communication network.

In another implementation of the first aspect, transmitting the configuration sets for the functionality to the UE includes transmitting the configuration sets for the functionality and an identification (ID) associated with the functionality to the UE in a radio resource control (RRC) message.

In another implementation of the first aspect, each configuration set is associated with a unique identification. Transmitting the message to the UE to use the first configuration set includes transmitting the unique identification associated with the first configuration set to the UE.

In another implementation of the first aspect, transmitting the configuration sets for the functionality to the UE includes transmitting several IDs to the UE in a first radio resource control (RRC) message, where each ID is associated with a corresponding configuration set; and after determining the change in the functionality of the UE, transmitting the configuration sets for the functionality to the UE in a second RRC message.

In another implementation of the first aspect, transmitting the message to the UE to use the first configuration set includes transmitting an ID associated with the first configuration set to the UE.

In another implementation of the first aspect, transmitting the message to the UE includes transmitting an ID associated with the first configuration set in one of UE assistance information (UAI), downlink control information (DCI), or medium access (MAC) control element (CE).

In another implementation of the first aspect, the network node is one of a base station (BS) or a location management function (LMF) server. A configuration sets is one of data collection configuration sets, inference configuration sets, or monitoring configuration sets. At least one of the configuration sets includes one or more AI/ML functionality model life cycle management (LCM) parameters and one or more legacy functionality specific parameters. The functionality is an AI/ML-enabled functionality associated with one of channel state information (CSI) estimation, CSI reporting, beam management, positioning, or mobility.

In another implementation of the first aspect, the at least one processor is further configured to execute the one or more computer-executable instructions to cause the network node to receive, from the UE, a message including one or more conditions in the UE side of the wireless communication network. Generating the configuration sets for the functionality for the UE includes generating the configuration sets based on the one or more conditions in the UE side of the wireless communication network.

In another implementation of the first aspect, the at least one processor is further configured to execute the one or more computer-executable instructions to cause the network node to determine one or more conditions in the network node side of the wireless communication network. Generating the configuration sets for the functionality for the UE includes generating the configuration sets based on the one or more conditions in the network node side of the wireless communication network.

In a second aspect of the present application, a method of configuring a functionality to a UE by a wireless communication network node is provided. The method includes generating several configuration sets for the functionality of the UE based on one or more capabilities of the UE; transmitting the configuration sets for the functionality to the UE; determining a change in a condition of the functionality of the UE; selecting a first configuration set, which is associated with the condition, for the functionality of the UE; and transmitting a message to the UE to use the first configuration set to configure the functionality of the UE based on the first configuration set.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating an example radio communication system, according to an example implementation of the present disclosure.

FIG. 2 is a sequence diagram illustrating an example message flow for configuration of an AI/ML enabled functionality of a UE based on a UE-sided model, according to an example implementation of the present disclosure.

FIG. 3 is a sequence diagram illustrating an example message flow of a signaling framework for changing the AI/ML functionality configuration set, according to an example implementation of the present disclosure.

FIG. 4 is a flowchart illustrating an example method/process performed by a UE for handling the predictive beam configurations, according to an example implementation of the present disclosure.

FIG. 5 is a sequence diagram illustrating an example message flow of the AI/ML enabled functionality configuration considering a UE-sided model and a proactive reporting, according to an example implementation of the present disclosure.

FIG. 6 is a flowchart illustrating an example method/process performed by a network node for configuring a functionality to a UE, according to an example implementation of the present disclosure.

FIG. 7 is a flowchart illustrating an example method/process performed by a UE for configuring a functionality to the UE, according to an example implementation of the present disclosure.

FIG. 8 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/ GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:

'QCL-TypeA': {Doppler shift, Doppler spread, average delay, delay spread}

'QCL-TypeB': {Doppler shift, Doppler spread}

'QCL-TypeC': {Doppler shift, average delay}

'QCL-TypeD': {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:

Single DCI based TDM PDSCH repetition;

Single DCI based FDM PDSCH repetition;

Multi-DCI based PDSCH;

TDM PDCCH repetition;

FDM PDCCH repetition;

Single DCI based TDM PUSCH repetition;

TDM PUCCH repetition;

SFN based PDCCH scheme;

SFN based PDSCH scheme;

Single DCI based FDM PUSCH repetition;

Multi-DCI based PUSCH;

FDM PUCCH repetition;

SFN based PUSCH scheme; and

SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected as the representative AI/ML sub-use cases. The first use case (BM-Case1) may be for spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the NW side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or Rx beam ID.

The second use case (BM-Case2) may be for temporal downlink beam prediction for Set A of beams based on the historic measurement results of Set B of beams. For the BM-Case2, the following alternatives may be considered. The AI/ML model training and inference may be done either at the NW side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the current implementation of the 3GPP, management of the beam prediction information, and configuration of the same to the UEs are not described. In addition, the UE and network behaviors are not specified in a case where the AI/ML beam prediction information is not accurate or does not match the actual beam measurements by the UE. Present disclosure provides mechanisms for the management and configuration of the (AI/ML) beam prediction information, as well as, for detection and reporting of inaccuracies in the (AI/ML) beam prediction information.

Several examples of the present embodiments are described using, for example, the Beam Management Case 2, as described above. In these embodiments, beam prediction using the AI/ML model may be performed at the UE side or at the network side using, for example, parameters like the actual or predicted L1-RSRP or using historic measurements of the beams, and/or any other AI/ML mechanisms. The present embodiments address the issues related to beam prediction information and related parameters, the application of beam prediction related parameters and its configuration procedure to the UE(s), the UE’s behavior when an actual beam is detected and how it maps to the beam prediction configuration provided, in advance, by the network. The present embodiments address the failure scenarios by defining the UE’s and network’s behavior when the network configured beam prediction configuration is not accurate and does not match the actual beam measurements by the UE.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like key performance indicators (KPIs), the AI/ML model may provide output in the form of F (f1,f2 … fn) predictions for T(t1,t2, … tn) future time instances. The prediction may reflect predicted beams and their corresponding configurations.

### BEAM PAIR SELECTION PROCESS

There may be three distinct DL processes of operations to obtain the best beam pair selection. These processes are colloquially referred to as P1, P2 and P3 in technical discussions and reports.

P1 is the initial process dedicated to the BS (e.g., gNB) beam selection. In P1, broad beams are typically used to sweep the angular space and a coarse serving direction may be chosen based on measurements from a broad-beam UE. P1 may be used to enable the UE measurement on different TRP Tx beams to support selection of the TRP Tx beams/UE Rx beam(s). Beamforming at the TRP, may typically include an intra/inter-TRP Tx beam sweep from a set of different beams. Beamforming at the UE may typically include a UE Rx beam sweep from a set of different beams. Before a data flow is enabled in the scheduler, periodic SSB beam scanning may be implemented on the BS side in a certain intervals (the SSB periodicity). At the same time, wide beam scanning may be implemented on the UE side to determine the optimal receive wide beam (the Optimal SSB/ Physical Random Access Channel (SSB/PRACH) beams).

P2 is the second process to refine P1’s beam selection using narrower BS beams. P2 may still employ a broad beam at the UE. P2 may be used to enable the UE measurements on different TRP Tx beams to possibly change the inter/intra-TRP Tx beam(s). P2 may use a possibly smaller set of beams for beam refinement than P1. It should be noted that that P2 may be a special case of P1, for example, by performing a beam sweep in a narrower angular sector than in P1. The narrow beams closest to the wide beam in the beam grid may be selected to be examined using CSI-RS (followed by CSI-report).

P3 is the final process of beam alignment for the UEs equipped to support beamforming. After beam selection at the BS side, the transmit beam may be fixed so the UE may refine its broad beam by sweeping through its own narrow beams. P3 may be used to enable the UE measurements on the same TRP Tx beam to change the UE Rx beam in the case the UE uses beamforming.

The optimal narrow beam may be selected from P2, and the CSI-RSs may be transmitted to the UE. The UE may update its Rx beam. In the data transmission, the BS may use the best BS Tx beam found during P2 and the UE may use the best UE Rx beam found during P3.

It should be noted that, while data transmission is being performed on an active beam pair link, the UE may monitor the PDCCH on another beam pair as a backup link for swift fallback if there is a sudden blockage of the active link.

### SYNCHRONIZATION SIGNAL BLOCKS

The Synchronization Signal/Physical Broadcast Channel (SS/PBCH) Blocks, typically shortened to SSBs, are a pivotal part of the NR. The SSBs may be broadcast periodically for the UE’s measurement purposes. A single SSB, spanning 4 OFDM symbols in time and 240 subcarriers in frequency, may include both synchronization signals and broadcast channels. The Primary Synchronization Signal (PSS) and the Secondary Synchronization Signal (SSS) may be carried in the SSB as two 127-long pseudo random binary m-sequences employed for initial synchronization and cell identification. The PBCH associated with the Demodulation Reference Signal (DMRS) may contain system control information that the UE may require to communicate with the network.

During the beam sweeping procedure, the SSBs may be transmitted in groups, known as SSBursts, according to a numerology-dependent transmission pattern. In Frequency Range 2 (FR2), an SSBurst may contain up to 64 SSBs. Each SSB may be mapped to a unique BS beam so that the UE may decode it, measure that beam’s power level, and report the beam’s L1-RSRP value back to the BS for beam determination. This may be done through SS-RSRP, which may be defined as the linear average over the power contributions in Watt of the resource elements that carry an SSS. For beam acquisition, SSBs are usually employed during P1, where broader beams are considered.

The CSI-RSs are UE-specific signals transmitted by the BS to monitor the DL radio channel conditions. These NR signals are extremely flexible, allowing for 18 different time-frequency allocation configurations tailored to a multitude of applications, such as, Channel State Information (CSI) acquisition, radio resource management (RRM), or beam management. For beam management, the CSI-RS may only be configured through three distinct configurations to be used, similarly to SSBs, in L1-RSRP measurements for beam candidate selection. This may be achieved using the CSI-RSRP, which is the linear average over the power contributions in Watt of the resource elements of the antenna port(s) that carry CSI-RS configured for RSRP measurements within the considered measurement frequency bandwidth in the configured CSI-RS occasions.

In the context of beam acquisition, the CSI-RSs are associated with narrower beams and, therefore, are employed in both P2 and P3, as described above. However, their configurations differ in a higher layer parameter named “repetition,” which displays a binary “on” or “off” state. The repetition parameter may only be set for the CSI-RSs that are configured for the L1-RSRP and it may let the UE make a determination regarding the DL beamforming configuration on the BS side. In P2, the repetition parameter may be set to “off,” entailing that the beamforming applied to each CSI-RS resource at the BS may vary. Therefore, the UE may take that information as an indication to maintain the same spatial filtering until P2 is complete. In P3, however, the repetition parameter may be set to “on,” which means that the UE may assume that no beam sweeping is performed on the BS side and, therefore, the UE is free to sweep through its own beams for the purpose of beam refinement.

RAN work group 2 (RAN WG2 or RAN2), during phase 1 discussions, has defined different functionality types for AI/ML functionalities. A functionality refers to an AI/ML-enabled feature or feature group facilitated by a configuration. A functionality, in the context of AI/ML-enabled 5G NR and beyond communication systems, refers to a specific feature or a collection of related features that are enabled by artificial intelligence or machine learning capabilities. These functionalities are supported and managed through configurations, which are sets of parameters or instructions that dictate how the AI/ML enabled 5G NR or beyond system should operate. Essentially, a configuration ensures that the functionality works correctly by providing the necessary settings and data for the AI/ML processes including the life cycle Management (LCM) of the AI/ML model/functionality to work effectively.

During the phase 1 discussion, the following definitions of functionalities have been summarized: (i) supported functionalities refer to functionalities that the user equipment (UE) can indicate by using UE capability signaling, (ii) applicable functionalities refer to functionalities that the UE is ready to apply for model inference, and (iii) activated functionalities refer to functionalities already activated and performing inference.

In phase 2 of the discussions, RAN2 has mainly focused on the signaling framework for the applicable functionality reporting. The applicable functionality is influenced by the NW and UE side additional conditions, which are dynamic in nature and may frequently change. As per the discussions in RAN2, most participants have the following opinion on the NW and UE side additional conditions. In both the NW-sided model and the UE-sided model, the UE-side additional condition may include the UE speed, scenario (e.g., urban, rural, macro, indoor, mobility, etc.), hardware capabilities, etc.

RAN2 has not provided an exact definition for the NW-side additional condition. However, RAN1 has summarized the NW-side additional conditions in the document R1-2405680 as follows: (i) mapping relationship of Set A and Set B, including ordering to a set of identifications (IDs), or resources, (ii) consistency of downlink spatial domain transmission filters corresponding to the beams in Set A and Set B, (iii) QCL assumption, (iv) the order of model input and model output between the Rx and Tx beams, which can be pre-defined, (v) transmission power, (vi) UE distribution, (vii) antenna height, (viii) deployment scenarios (e.g., inter-site distance (ISD), urban microcell/urban macrocell (Umi/Uma)), and (ix) ensuring consistency across different cells.

Thus, considering the on-going RAN2 discussions, the following problem has been identified. Due to the dynamic and variable nature of the NW and UE side additional conditions, the AI/ML applicable functionality may need to be adapted by frequent re-configuration. This may require extensive signaling to fully re-configure the appliable functionality, which may lead to interruptions and delays. Full reconfiguration of an AI/ML functionality is done by using RRC signaling. Each RRC reconfiguration involves a series of complex procedures and exchanges of signaling information between the UE and the network, which may momentarily halt data transmission and processing. This may result in noticeable disruptions, increased latency, and a degraded user experience as the network and the UE adjust to new parameters and settings.

Some embodiments provide a novel solution to address the above-mentioned issues and provide a lightweight signaling mechanism to address the dynamicity of the variable conditions and consequent changes in the applicability of an AI/ML that a UE experiences. Some embodiments describe a method for configuring multiple sets of configurations to the UE for a given AI/ML functionality, a mechanism to change the configuration sets based on changes in the UE environment or additional conditions, and a mechanism to indicate a default or preferred configuration set, by the network and/or UE. Some embodiments may provide the UE behavior upon receiving the change in the configuration set indication. The scenarios with proactive and reactive reporting have been considered within the scope of the provided solution.

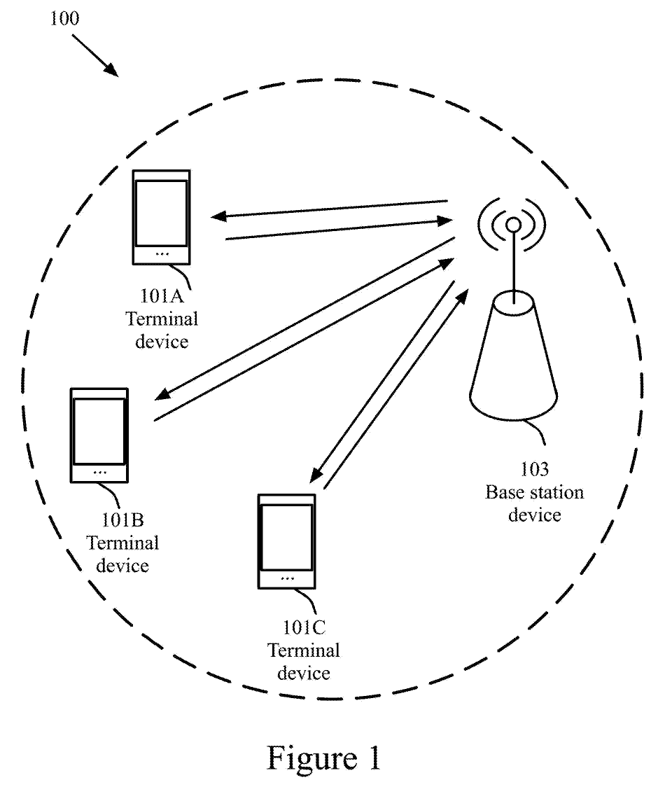

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 may be configured of multiple transmission/reception devices, each of the multiple transmission/reception devices may be arranged at a different position. A transmission/reception device may include a transmission device and/or a reception device.

BS 103 may serve radio communication and provide one or more cells. A cell is defined as a set of resources used for a wireless communication. A cell may include one or both of a downlink component carrier and an uplink component carrier. A serving cell may include a downlink component carrier and two or more uplink component carriers.

The BS 103, or another network entity, such as a location management function (LMF) server, in some embodiments, may provide multiple sets of configurations to a UE 101A-101C for a given AI/ML functionality. The BS 103, or the other network node, may provide a mechanism to change the configuration sets based on changes in the UE environment or additional conditions.

In a wireless communication system, the RRC configuration process is necessary for setting up, maintaining, and modifying the radio connection between the UE and the BS (e.g., a gNB) in the 5G/5G-Advanced (5G-A) networks. The BS 103 or the network entity, may send an RRC message to a UE 101A-101C to configure at least one of the configuration parameters or features of a configuration set. This RRC message may be, for example, RRCSetup, RRCReconfiguration, RRCResume, RRCRelease, or other downlink messages generated by the BS 103 or another network entity. The BS 103 and/or the other network entities are considered as components of the network. In the following discussions, the term network node refers to any network entity, such as, BS (e.g., gNB), LMF server, etc., and the BS 103 may be used as an example of such network node.

### RRC CONFIGURATION

The main components and steps for the RRC configuration process include RRC connection establishment, RRC connection reconfiguration, and RRC connection release. In the RRC connection establishment step, the UE may send an RRCConnectionRequest message to the BS 103. The BS 103 may respond with an RRCConnectionSetup message. The UE may acknowledge with an RRCConnectionSetupComplete message.

The RRC connection reconfiguration process may modify the existing RRC connection to update parameters, such as, radio bearers, measurement configurations, mobility settings, etc. The BS 103 may send an RRCConnectionReconfiguration message to the UE 101A to 101C. The UE 101A to 101C may acknowledge with an RRCConnectionReconfigurationComplete message after applying the new configuration.

The RRC connection release process may terminate the RRC connection and move the UE into an idle state. The BS 103 may send an RRCConnectionRelease message to the UE 101A to 101C. After receiving the RRCConnectionRelease message, the UE may transition to the idle mode.

The detailed procedure for the RRC configuration is discussed in the technical specification TS 38.331. The RRCConnectionReconfiguration messages may be used to configure and modify functionalities. The RRC configuration may include multiple configuration aspects like radio bearers, measurements, mobility, and other advanced features. The RRC may configure functionalities, such as, CSI reporting, beam management, handover, carrier aggregation, etc.

Some embodiments may provide a method to configure multiple sets of configuration to the UE for a given AI/ML functionality. The method may indicate, change, or modify the configuration sets based on changes in the UE environment or additional conditions. The method may configure the UE with proactive or reactive reporting capabilities.

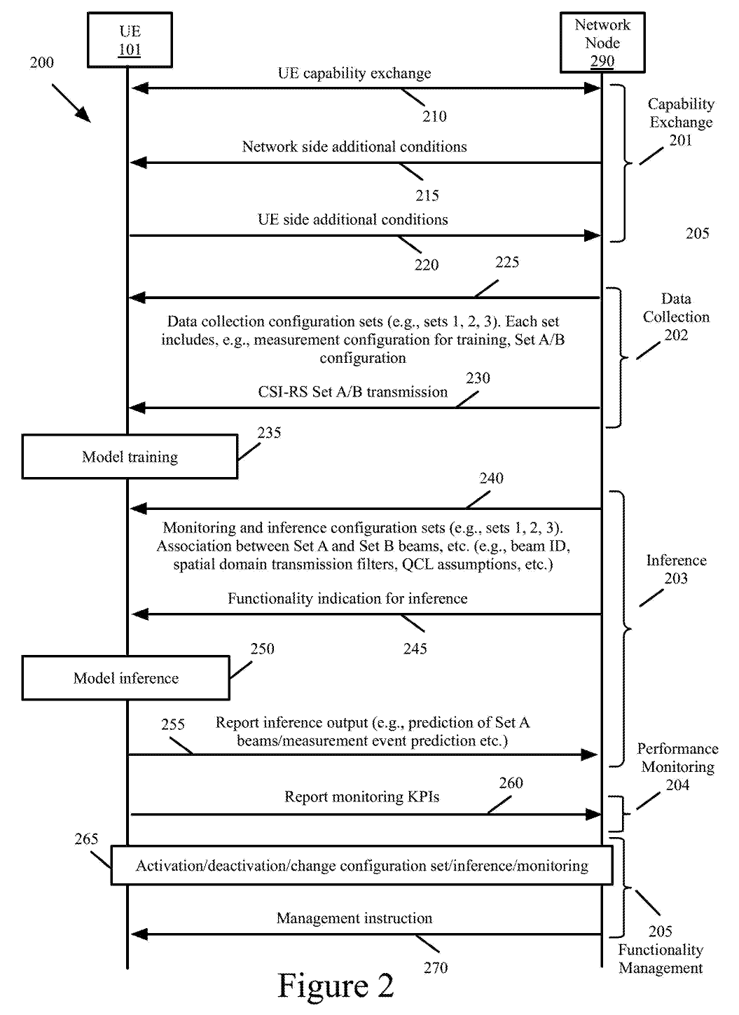

FIG. 2 is a sequence diagram 200 illustrating an example message flow for configuration of an AI/ML enabled functionality of a UE based on a UE-sided model, according to an example implementation of the present disclosure. The wireless communications system may be, for example, a 3GPP network, such as, the 5G/5G-A or the 6^{th} generation (6G) NR system. The UE 101 may be any of the UEs 101A-101C and the network node 290 may be the BS 103 shown in FIG. 1 or any other network entity, for example, an LMF server.

The capability exchange 201 between the UE 101 and the network node 290 is described in steps 210-220. The signaling between the network node 290 and the UE 101 for the capacity exchange 201 may be, for example, RRC signaling.

In step 210, the UE 101 and the network node 290 may exchange the UE capabilities using the UE capability exchange procedure, which is described in the technical specification 3GPP TS 38.331 for 5G NR. In this step, the UE 101 may indicate the supported functionalities to the network node 290. After exchanging the UE capabilities, the network node 290 may indicate (as shown in step 215) the network side additional conditions to the UE. The network side additional conditions may include, for example, the mapping relationship of Set A and Set B (including ordering to a set of IDs, or resources), consistency of downlink spatial domain transmission filters corresponding to the beams in Set A and Set B, QCL assumption, the order of model input and model output between the Rx and Tx beams that can be pre-defined, transmission power, UE distribution, antenna height, deployment scenarios (e.g., ISD, Umi/Uma), and ensuring the consistency across different cells.

The UE 101 may indicate (as shown in step 220) the UE side additional conditions to the network node 290. The UE-side additional conditions may include, for example, the UE speed, scenario, hardware capabilities, etc.

The UE 101 may perform data collection 202 in steps 225-230. The signaling between the network node 290 and the UE 101 for data collection 202 may be, for example, RRC signaling. In step 225, the UE may receive data collection configuration sets (e.g., data collection sets 1, 2, 3) from the network node 290. The configuration for data collection may depend on the purpose for which the data is collected. For example, whether the data is collected for model training, monitoring, or inference. The configuration sets may include, for example, but not limited to, data type, format, historic data, real time data, periodic and aperiodic measurement and reporting settings, specifying periodicity, offset, and triggering conditions for measurement and reporting, etc. In some embodiments, each data collection configuration set may include, for example, measurement configuration for training, beam Set A/B configuration, etc. The UE 101 may also use the configuration sets to determine what kind of data is to be collected.

The network node 290 may transmit the CSI-RS Set A/B to the UE 101 in step 230. The UE 101 may perform model training in block 235 using the data collected in steps 225-230. The AI/ML model training is the process of feeding the collected data to selected algorithms to help the AI/ML model refine itself to produce accurate responses to different queries and make accurate predictions. It should be noted that the model training may be done at the UE, a UE-side server, a UE side entity, for example, an OTT training server, or a network side entity, but a part of the data required for model training may be collected by the UE.

The inference 203 is described in steps 240-255. The inference is the process that a trained model uses to draw conclusions from new data. The signaling between the network node 290 and the UE 101 for inference 203 may be, for example, RRC signaling. In step 240, the UE 101 may receive monitoring configuration sets (e.g., monitoring configuration sets 1, 2, 3) and inference configuration sets (e.g., inference configuration sets 1, 2, 3) from the network node 290. The network node 290 may send the monitoring configuration sets and the inference configuration sets to the UE 101 in one message or in two separate messages. The UE 101 may also receive the association between Set A and Set B beams, etc., from the network node 290. For example, the UE 101 may receive beam ID, spatial domain transmission filters, QCL assumptions, etc., from the network node 290. The UE 101 may receive functionality indication for inference from the network node 290 in step 245. The UE may perform inference using the AI/ML model in step 250. The UE 101 may report inference output (e.g., prediction of Set A beams/measurement event prediction, etc.) to the network node 290 in step 255.

The UE may perform performance monitoring 204 in step 260. In this step, the UE 101 may report the results of monitoring KPIs to the network node 290. For example, the UE 101 may report prediction of Set A beams, measurement event predictions, etc.

The functionality management 205 may be performed in steps 265-270. In step 265, activation, deactivation, change configuration set, inference, and/or monitoring may be performed. The network node 290 may indicate that functionality/model activation/deactivation, change configuration set, inference, and/or monitoring may be performed. The UE may do these operations autonomously or the network node and the UE may do it jointly. The network node 290 and the UE 101 may use the configuration set ID, for example, the index number or L1/L2/L3 DCI, MAC /RRC or a higher layer type message to perform this.

In some of the disclosed embodiments, a configuration set may include multiple configurations and if the network node 290, the UE 101, or both select, deselect, or disable one of the configurations, the selection may implicitly act as the activation/deactivation, etc. In some of the present embodiments, the network node 290 and the UE 101 may perform a joint approach, where the UE indicates the UE’s preferred action to the network node. The network node 290 may then make the final decision. The preferred action may be, for example, change configuration, activate/deactivate functionality, fall back, fully reconfigure the functionality, etc.

The network node 290 may send management instructions to the UE 101 in step 270. The network node 290 may configure a UE that is allowed to indicate its applicable functionalities based on additional conditions. The UE 101 may report the applicable functionalities to the network node 290 upon change of applicable functionality or additional condition(s). It should be noted that the network node 290 may provide inference, monitoring, or data collection configurations or any other configuration before or after the UE reports the applicable functionality. It may be up to implementation or depend on whether a proactive or reactive approach is used. The description for the proactive and reactive reporting may be found in the technical report 3GPP TR 38.843. A comparison for proactive reporting and reactive reporting based on the on-going 3GPP discussions is summarized as follows.

The RRCReconfiguration message in the proactive reporting - This message from the network includes only the associated ID(s) of the functionalities that might require AI inference by the UE.

The inference configuration in the proactive reporting - This information, which specifies details like Set A configuration (relevant beams for the model), is not provided to the UE in the same RRCReconfiguration message.

The UE action in the proactive reporting - Upon receiving the message, the UE can only identify the functionalities that might be relevant. The UE cannot perform inference yet.

Additional message in the proactive reporting - The network has to send another message containing the inference configuration for each associated ID before the UE can start inferencing.

Reporting versus configuration in the proactive reporting - The proactive reporting focuses on informing the UE about potentially relevant functionalities, but the actual configuration for inference comes later.

The RRCReconfiguration message in the reactive reporting - The RRCReconfiguration Message includes both the associated ID(s) and the corresponding inference configuration.

The inference configuration in the reactive reporting - Details like Set A configuration are included alongside the associated ID within the same RRCReconfiguration message.

The UE Action in the reactive reporting - The UE receives all the necessary information (associated ID and inference configuration) in a single message. The UE can immediately perform inference for functionalities identified as applicable based on the received configuration.

Reporting and configuration are combined in the reactive reporting - The reactive reporting provides both the functionality identification (reporting) and the configuration details (inference configuration) in one message.

The proactive reporting may be preferred when the network is unsure about the specific inference needs at a given time. The proactive reporting avoids sending unnecessary configuration for functionalities that might not be relevant. The reactive reporting offers faster reaction times for the UE as it may start inferencing immediately upon receiving the RRCReconfiguration message. This may be beneficial for functionalities requiring real-time decisions.

The term "configuration," herein, refers to the arrangement and specification of components, settings, or parameters within a system or device as defined by the applicable agreements, standards, or specifications. The term encompasses the established setup and customization of elements necessary to ensure compliance with contractual obligations, operational requirements, and performance criteria.

In steps 225 and 240 shown in FIG. 1, the network node 290, in some embodiments, may send configuration for the applicable functionalities to the UE 101 that may include configuration for inference, monitoring, and data collection for training. Within this configuration, the network node 290 may configure the functionality within the UE with one or multiple sets of configuration related AI/ML functionality which may impact the AI/ML model LCM for each of the sub-functions of the functionality (e.g., individual configuration sets for monitoring, inference, and data collection). In other embodiments, steps 225 and 240 may be performed in a single message or in a different message and in any order.

The UE 101 may store one or multiple sets of functionality configurations, for example, multiple data collection configuration sets, multiple monitoring configuration sets, and/or multiple inference configuration sets for the given applicable functionality(s) provided by the network. In some embodiments, the network node 290 may configure an AI/ML functionality within a UE with one or multiple sets of configuration for the UE. The configuration sets may have detailed system and parameter setting information for data collection for model training, monitoring, and inference respectively. Other aspects, such as, generation and processing of the collected data may also be configured in a configuration set. One or more configuration sets may be stored at the UE for each functionality in a customized manner that helps in overall AI/ML model life cycle management to increase system efficiency and performance.

When the UE applies a configuration set, the UE implements and conforms to the parameters and conditions stipulated within that configuration set as defined. The configured set for a UE pertaining to a target functionality may encompass the following information. For data collection, the network, in some embodiments, may create a configuration set that may include measurement configurations for training, monitoring, and inference, considering, for example, beam configuration for Set A/B.

The measurement configuration and reporting, for example, may have the following information: contents, type and format of data including data related to model input, data related to ground-truth, quality of the data, other information, signaling of assistance information for categorizing the data, etc. Based on the type of collected data, the network may configure where to transfer the data (CN, over the top (OTT), BS, etc.).

The network may configure the UE to perform the specific measurements through RRC signaling, typically using the RRCReconfiguration message. This message may include parameters, such as, measurement objects, reporting configurations, and measurement identities. The measurement objects parameters may define the cells or beams that the UE has to measure. For beam management, this may include reference signals (e.g., Set A/B beams) from the neighboring cells or beams within the serving cell. The reporting configurations parameters may specify the conditions under which the UE has to report measurement results. The conditions may be event-triggered (e.g., a certain signal strength threshold is crossed) or periodic.

For the AI/ML-enhanced beam management, the configurations might include more sophisticated triggers based on predicted mobility patterns or beam quality metrics. In case of the AI/ML-enabled functionality, the measurement configuration may include parameters that is listed in the text (e.g., data type, format etc.) that may indicate to the UE what data type to collect for a specific model/functionality. For example, this maybe a new type of measurement object. The UE may optionally report multiple instances of logged L1 measurement results to the BS via an RRC message as configured by the BS.

For model training, the training data may be generated by the UE or the BS. The configuration for data collection may depend whether the data is collected for model training, monitoring, or inference. The configuration sets may also include periodic and aperiodic measurement and reporting settings, specifying periodicity, offset, and triggering conditions for measurement and reporting.

The data needs to be collected for functionality monitoring and inferencing. The collected data is used in the overall functionality management. In some embodiments, based on the target use-case, such as, beam management, CSI estimation, etc., the network may create one or multiple configuration sets for monitoring and inferencing. For monitoring, for example, the configuration sets may contain information such as KPIs or metrics to monitor,

As an example, for beam management functionality, the network may consider the following metrics, which may be calculated in different ways using different parameters as follows. It should be noted that the following is just an example provided for explanation purposes. For different functionalities, performance metrics and their calculation methods may be different.

For the Beam Prediction Accuracy (Alt. 1), the metrics may include Top-K/1 beam prediction accuracy, accuracy within a specific decibel (dB) margin, matching predicted and measured Top-K beams, and ranking/ordering accuracy of predicted beams.

For the L1-RSRP Measurement (Alt. 2), the metrics may include measured L1-RSRP of configured resources, the difference between the measured and predicted Top-K beam L1-RSRP reporting the predicted L1-RSRP for the Top-1 beam (if supported by the model), and hypothetical block error rate (BLER)-like metrics based on monitoring reference signal (RS) resources.

For the Prediction Confidence (Alt. 3), the metrics may include the probability of predicted beam being the Top-1, the confidence interval for the predicted L1-RSRP, and the probability of the Top-1 beam having low confidence.

For the overall prediction error (Alt. 4), the metrics may include the L1-RSRP difference between the measured and predicted beams, the difference between the measured RSRP and the predicted RSRP (Genie-aided or Top-K average), and the L1-RSRP difference between the measured current beam and the predicted Top-1 beam.

For the beam management use cases, the new configuration sets may, for example, include the followings. For model training, the training data may be generated by the UE, the BS, or any other entity. For the NW-side model inference, the input data may be generated by the UE and terminated at the BS. For the UE-side model inference, input data is internally available at the UE. For performance monitoring at the NW side, the calculated performance metrics (if needed) or data required for performance metric calculation (if needed) may be generated by the UE and terminated at the BS.

The UE may monitor the performance of the UE-side model. For monitoring at the network side of the UE-side model, the UE may generate, if needed, the calculated performance metrics or data required for performance metric calculation, while the termination point for these is the BS. For the network-side model, the monitoring may reside within the BS.

The network may configure within the configuration message framework of the present embodiments where the performance metrics are calculated (location, e.g., the UE or the network). Following this, in some embodiments, the network may indicate which configuration set should be activated using Layer 1/Layer 2/Layer 3 (L1/L2/L3) signaling or messages like user assistance information (UAI), for example, using an RRC message or MAC CE. Before receiving a first RRC message or a MAC CE after the reception of the RRC reconfiguration message (e.g., after the configuration of the configuration set is complete), the UE may not just activate any configuration set randomly. Therefore, the UE cannot activate AI/ML functionality. To solve this, some embodiments may define a default configuration for a functionality. The default configuration may be activated right after the RRC reconfiguration. For example, the default configuration set may be a set configured with index 0. The RRC reconfiguration message may provide information on which set is the default. In some embodiments, if the network wants to use or apply a custom configuration set different than the default set, the network may configure it with a custom index, for example, an index x, where x is not equal to 0.

Some embodiments may provide a mechanism to indicate the default or preferred configuration set by the network and/or the UE and define the UE behavior upon receiving a change in configuration set indication. The network, in some scenarios, may select and indicate the configuration set(s) to the UE. In some scenarios, the UE may autonomously select a configuration set, apply the configuration set, and indicate the changes to the network.

### INFERENCE

For inferencing, as mentioned in the technical report TR 38.843, for all types of offline model training (e.g., UE, NW, two-sided model training), there is no latency requirement for data collection. However, for model inference, when the required data comes from other entities, there is a latency requirement for data collection. For real-time performance monitoring, when the required monitoring data (e.g., performance metric) comes from other entities, there is a latency requirement for data collection. Thus, in some embodiments, depending upon the use-case at the specific scenario, the BS may configure one or more configuration sets for inference reporting which may include parameters, for example, time information for model inferencing, timeline (e.g., periodic/aperiodic, based on triggers, or in a scheduled manner) and conditions for reporting of inference results, prediction window.

In some embodiments, the configuration sets may be provided to the UE by the network when the network sends inference configuration for the applicable functionalities to the UE. One or multiple sets for an AI/ML functionality monitoring and inference may be configured. As discussed above, there are three types of functionalities: supported functionalities, applicable functionalities, and activated functionalities. The full or initial/partial configurations or configuration set to the UE may be provided before or after the UE reports the applicable configurations. If the full or initial/partial configurations or configuration set is provided before the UE reports the applicable functionalities, per the definition, the configurations are for one or more supported functionalities. Applicable functionality(s) are a sub-set of supported functionality(s) that are valid based on certain conditions at a given time. Therefore, the network may provide full or initial/partial configurations (subset of full configuration), for example, for the AI/ML functionality monitoring and inferencing at any time. It should be noted that the network side additional conditions may also be indicated to the UE within the configuration sets either together with inference configuration or in a different configuration separately.

As described above, RAN1 summarized NW-side additional conditions in summarized in the document R1-2405680 as follows: (i) mapping relationship of Set A and Set B, including ordering to a set of IDs, or resources, (ii) consistency of downlink spatial domain transmission filters corresponding to the beams in Set A and Set B. (iii) QCL assumption, (iv) the order of model input and model output between RS and Tx beams can be pre-defined, (v) transmission power, the UE distribution, antenna height, deployment scenarios (e.g., ISD, Umi/Uma), and ensuring consistency across different cells.

The primary goal of the NW-side additional conditions is to ensure that the conditions under which the AI/ML models are trained are consistent with the conditions under which inferences are made. For example, for the beam management use case, it is crucial to maintain the same beam codebook and the same indexing/mapping of Set A and Set B during both the training and inference phases. For instance, if a model is trained using a dataset with a specific beam codebook and a particular index/mapping of Set A and Set B, the inference may only be accurate if the same beam codebook and indexing/mapping of Set A and Set B are used. The BS may provide an ID, for example, data set ID, or associated ID, etc., that may correspond to a specific NW-side additional condition or other set of parameters within a defined configuration.

It is assumed that both the UE and the BS understand the information linked to the associated ID. For example, a particular associated ID may correspond to a specific beam codebook and the associated index/mapping of Set A and Set B. When this ID is used, both the UE and the BS know that they need to use the beam codebook and indexing/mapping associated with that ID.

The followings describe the application of configuration sets, with the beam management functionality as an example use case. The principles and methodologies discussed herein may similarly be applied to the configuration of other functionalities. The configuration sets may include information related data collection, monitoring, inferencing and parameters or settings related to the main functionality configuration.

In the beam management functionality, while configuring multiple configurations sets, each set may include, for example, but not limited to, the following information or parameters.

The CSI-ReportConfig configuration may include the following parameters and/or information. The CSI parameter may include the configuration for CSI reporting, which may include the resources and settings for measuring and reporting the channel state. The reporting periodicity parameter may specify how often the UE should report the CSI measurements, including periodic and aperiodic reporting. The resources parameter may define which resource sets (e.g., Set A and Set B) are used for measurements and reporting. The CSI-ReportConfig is a configuration in 5G NR that defines how the CSI is reported by the UE to the network. This configuration is critical for optimizing various network functions, such as beam management and resource allocation.

The CSI-ResourceConfigId configuration may include the following parameters and/or information. The resource sets parameter may include the identifiers for resource sets configured for beam measurements. The resource sets parameter may include Set A - the currently active or candidate beams, Set B - Potential beams for future use or under consideration for beam switching/handover, and/or QCL Assumptions -Assumptions about the spatial relationships between different beams.

The Beam and Transmission (Tx) Port Mapping configuration may include the following parameters and/or information. Beam IDs - Beam Identification for communication and Tx Ports - Configuration of transmission ports associated with each beam.

The Antenna Configuration, which may be considered as network side additional conditions, may include the following parameters and/or information. Antenna Pattern - Information regarding shape and directionality of the antenna, Antenna Height - Height of the gNB antenna, which affects beam propagation, and Dip Angle - The angle at which the antenna is tilted, impacting coverage and performance.

The Performance Monitoring and Data Collection configuration, also referred to as the monitoring configuration, may include the following parameters and/or information. The KPIs parameter may include metrics like signal strength, Signal-to-Interference-plus-Noise Ratio (SINR), and throughput, Beam Prediction Accuracy, Prediction Confidence, L1-RSRP etc. The measurement reports may include continuous collection of data from the UE for analysis and model training. Any additional parameters as discussed in the monitoring section of the present invention. For example, the location for calculation of performance metrics, such as the UE, the network, or any other entity.

The AI/ML Model Configuration may include the following parameters and/or information. The model Parameters and Model Type may include specific parameters and settings for the AI/ML model used for beam prediction. The Inference Execution may include timing and process for executing model inferences. The Training Data may include the historical and real-time data used to train the AI/ML model.

The Network Assistance Information configuration may include the following parameters and/or information. The Assistance Data may include data provided by the network to assist the UE in beam selection, such as expected beam quality and mobility patterns. The contextual Information may include information about the environment, including UE location, speed, and direction.

Thus, considering the above information, as a non-limiting example, the following three different inference configuration sets may be created. Configuration Set 1: Basic Beam Inference Configuration. Configuration Set 2: Advanced Multi-Beam Inference Configuration. Configuration Set 3: Context-Aware Beam Inference Configuration. It should be noted that various combinations and parameters may be used to create additional configuration set types. Sets 1, 2, and 3 are provided solely for illustrative purposes.

In some embodiments, the network may configure the functionality set(s) which may include one or more of the component parameters discussed above. For example, not all the components of the set may need to be present in a functionality set configuration and only a set of components may be present. For example, a set, such as set m, may have the following set of components defined, CSI-ReportConfig, Performance Monitoring only. Another set, such as set n, may have the following set of components Performance Monitoring, AI/ML Model, CSI-ReportConfig.

### SET 1 - BASIC BEAM INFERENCE CONFIGURATION

The objective of Set 1 is to provide a straightforward beam selection mechanism based on real-time CSI. This may be used as a default configuration set. Set 1 may include the following components.

The CSI-ReportConfig in Set 1 may include the followings. Periodicity - High frequency (e.g., every 10ms) to ensure up-to-date channel information. Resources - Set A includes currently active beams.

The ResourceConfigId in Set 1 may include the followings. Set A - Active beams being measured.

The QCL Information in Set 1 may include the followings. Assumptions - Beams are assumed to have minimal spatial correlation (simple QCL assumptions).

The AI/ML Model in Set 1 may include the followings. Input Data - Real-time CSI measurements (e.g., RSRP, SINR). Inference - Simple decision tree model to select the best beam based on the highest signal quality. Model type and parameters.

The Performance Monitoring in Set 1 may include the followings. KPIs - RSRP, SINR. The Performance Monitoring in Set 1 may also include any additional parameters as discussed in the AI/ML functionality monitoring section of this invention report.

It should be noted that the CSI-ReportConfig, ResourceConfigId, and QCL Information parameters are legacy parameters, and the AI/ML Model and Performance Monitoring parameters are AI/ML related parameters.

### SET 2 - ADVANCED MULTI-BEAM INFERENCE CONFIGURATION

The objective of Set 2 is to enable more complex beam management, including the prediction of beam quality and preemptive beam switching based on historical data and real-time measurements. Set 2 may include the following components.

The CSI-ReportConfig in Set 2 may include the followings. Periodicity - Moderate frequency (e.g., every 20ms). Resources - Set A includes active beams, Set B includes candidate beams for future handover. The ResourceConfigId in Set 2 may include the followings. Set A - Active beams. Set B - Candidate beams. The QCL Information in Set 2 may include the followings. Assumptions - Detailed spatial correlations between beams in Set A and Set B. The AI/ML Model in Set 2 may include the followings. Input Data - Combination of historical CSI data and real-time measurements. Inference - Neural network model to predict future beam quality and recommend preemptive beam switching. Model type and parameters.

The Performance Monitoring in Set 2 may include the followings. KPIs - RSRP, SINR, and Handover success rate. The Performance Monitoring in Set 2 may also include any additional parameters as discussed in the AI/ML functionality monitoring section of this invention report.

### SET 3 - CONTEXT-AWARE BEAM INFERENCE CONFIGURATION

The objective of Set 3 is to utilize contextual information such as UE location, speed, and surrounding environment for dynamic beam management. Set 3 may include the following components. The CSI-ReportConfig in Set 3 may include the followings. Periodicity - Variable frequency based on UE speed (e.g., higher frequency for high mobility scenarios). Resources - Set A includes active beams, Set B includes beams used in similar scenarios. The ResourceConfigId in Set 3 may include the followings. Set A - Active beams. Set B - Beams used in similar contextual scenarios (e.g., previous beams used at the same location). The QCL Information in Set 3 may include the followings. Assumptions - Advanced spatial correlations considering UE movement patterns. The AI/ML Model in Set 3 may include the followings. Input Data - Real-time CSI, historical data, and contextual information (e.g., global positioning system (GPS) coordinates, speed). Inference - Hybrid model combining machine learning and rule-based logic to adapt beam selection based on the UE's context. Model type and parameters. The Performance Monitoring in Set 3 may include the followings. KPIs - RSRP, SINR, and Mobility performance (handover delay, interruption time). The Performance Monitoring in Set 3 may also include any additional parameters as discussed in the AI/ML functionality monitoring section of this invention report.

Thus, the network may configure the UE with, for example, with the 3 configuration sets discussed above. The network may use L1/L2/L3 signaling (e.g., DCI, MAC CE, RRC, UAI etc.) to activate or change these configuration sets. The network may indicate the (pre) configured sets to the UE(s) as depicted in step 225 and 240 in FIG. 1.

In some embodiments, the network node may provide the UE multiple partial or full configurations in one step or different steps. The full configurations may be comprehensive configurations provided by the network that allow the UE to fully understand and utilize the functionalities such as, for example, CSI-ReportConfigs. The UE may use these full configurations to perform tasks and reporting as required.

The partial configurations may be subsets of full configurations that include only a portion of the necessary information. The UE may potentially use the partial configurations to determine if certain functionalities are applicable without needing the entire configuration upfront.

The UE may be configured with multiple partial configurations by the network and the UE may then indicate which partial configuration is applicable. Following this, the network may provide the corresponding full configuration to the UE. The UE may use partial configurations to evaluate whether a functionality is applicable. This means that even without having the full set of configuration parameters, the UE may still make an informed decision about the applicability of a functionality.

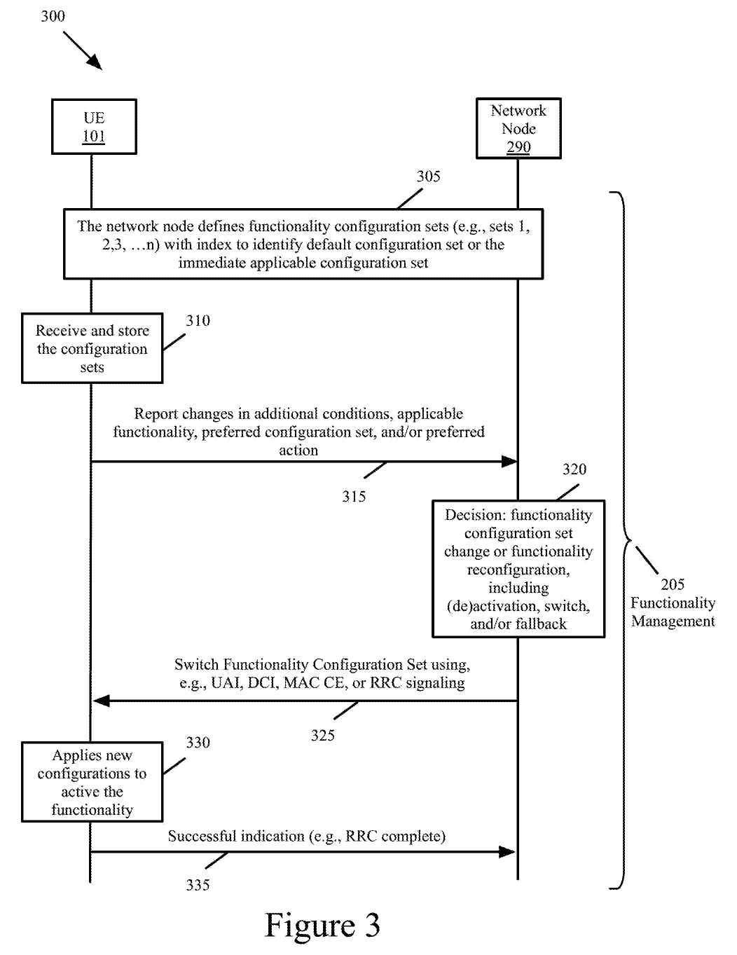

FIG. 3 is a sequence diagram 300 illustrating an example message flow of a signaling framework for changing the AI/ML functionality configuration set, according to an example implementation of the present disclosure. The functionality management 205 may be performed in block 305 to step 335 of FIG. 3. Once one or more configuration sets for an AI/ML functionality has been determined, the network node 290 may indicate the (pre) determined functionality configuration set(s) to the UE 101. The network node 290 and the UE 101 may exchange capability information using the capability exchange procedure.

In block 305, the network node 290 may configure the AI/ML enabled functionality(s) to the UE 101. For example, the network node 209 may define functionality configuration sets (e.g., functionality configuration sets 1, 2, 3, …, n) with indexes to identify the default configuration set or the immediate applicable configuration set. The network may also configure proactive reporting to the UE and request the UE to report applicable functionalities.

In some embodiments, the network node 290 may also send one or more functionality configuration sets to the UE 101 with an index to determine a default set or an immediately applicable set other than the default set. The network node 290 may configure functionality sets (e.g., sets 1,2, 3, … , n). The network node 290 may use index 0 to identify the default set and may use another index (e.g., index 1) to identify the set that the UE may need to apply immediately. If index 1 is not defined, then the UE may apply the default set.

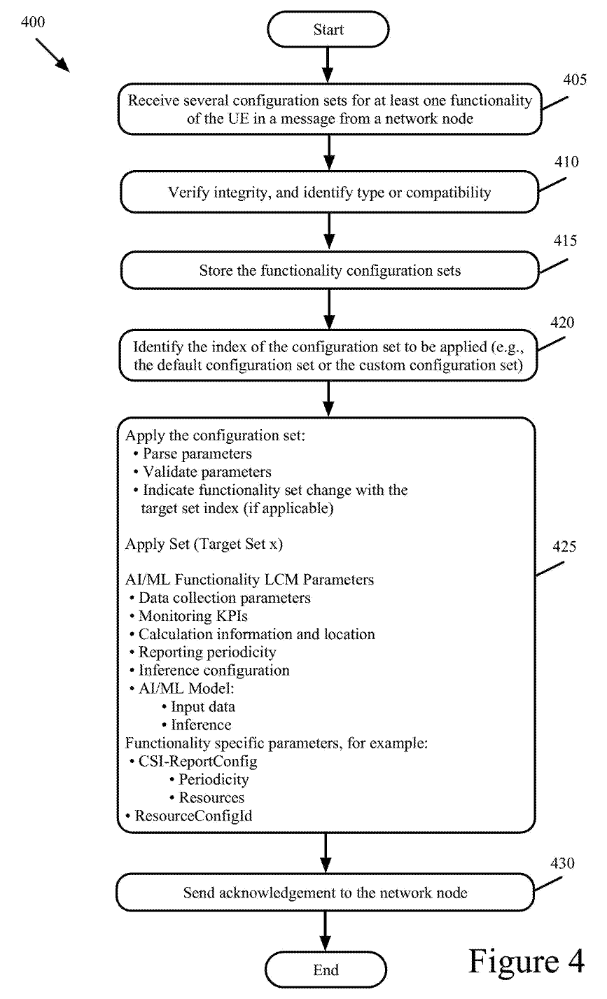

In block 310, the UE 101 may receive and store the functionality sets. Further actions performed by the UE are described below with reference to FIG. 4. In step 315, in case of changes to any additional conditions, the UE 101 may report the changes to the network. These changes may be, for example, changes in the additional conditions, applicable functionality, etc. In some embodiments, if the UE prefers to change the functionality reconfiguration set, or in case the UE has a preferred action, the UE 101 may indicate this to the network with or without a preferred configuration set. The UE 101 may also report its preferences. For example, the UE 101 may change the AI/ML functionality configuration set, complete re-configuration of the AI/ML functionality, functionality (de) activation, switch, fall back, etc. In one option, the UE may autonomously select one configuration and report it to the network. As another option, the UE may report the UE’s preferences to the network node and the network node may decide.

In some embodiments, when the UE detects changes in additional conditions or a change in the state of the applicable functionality, it may autonomously select an appropriate configuration from the set of configurations defined by the network and indicate this change to the network using, for example, UAI, MAC, or RRC signaling. Any other signaling is not excluded.

In block 320, the network node 290 may decide the next action based on the UE 101 response received in step 315. For example, if the network node 290 decides to change the configuration set, the network node 290 may send an indication to the UE 101 using L1/L2/L3 signaling or messages like RRC, MAC, UAI, higher layer signaling, etc. The network node 290 may also decide to do a functionality reconfiguration, including (de)activation, switch or change the functionality configuration set, and/or fallback to a previous functionality configuration data set.

In step 325, the network node 290 may indicate functionality set change to the UE 101 using for example, UAI, DCI, MAC CE, RRC, etc. In block 330, the UE 101 may apply the new configuration set to activate the functionality. In step 335, the UE may send a successful/complete indication (e.g., an RRC complete message) to the network.

FIG. 4 is a flowchart illustrating an example method/process 400 performed by a UE for handling the predictive beam configurations, according to an example implementation of the present disclosure. The process 400 may be performed by at least one processor of a UE 101A-101C, shown in FIG. 1.

The process 400 may receive (at block 405) several configuration sets for at least one functionality of the UE in a message from a network node. The message may, for example, be an RRC message. The process 400 may verify (at block 410) the integrity and identify the type or compatibility of the configuration sets. For example, the UE may map a configuration set to an applicable functionality by using, for example, index, ID, or similar information. It should be noted that there may be many configurations and multiple applicable functionalities. Therefore, the UE needs to know which configuration set (which may include multiple configurations) belongs to which functionality.

The process 400 may store (at block 415) the functionality configuration sets. The process 400 may identify (at block 420) the index of the configuration set to be applied. For example, the process 400 may identify the default configuration set or the custom configuration set to be applied immediately.

The process 400 may then apply (at block 425) the configuration set that was identified in block 420. For example, the process 400 may parse the parameters in the configuration set, may validate the parameters, and may indicate the functionality set change with the target configuration set index (if applicable). The process 400 may apply the configuration set that is identified as the target configuration set.

The target set x is the new configuration set provided by the network that the UE may apply and start using for a given functionality, for example, functionality A. The UE may discard the old configuration set. It may be implicitly used to (de)activate a functionality.

The non-limiting example of the parameters may include the followings. The AI/ML Functionality LCM Parameters may include data collection parameters, monitoring KPIs, Calculation information and location, reporting periodicity, and/or inference configuration. The AI/ML Model parameters may include input data, and inference. The functionality specific parameters, may include, for example, the CSI-ReportConfig component with the following parameters periodicity, and resources. The functionality specific parameters, may include, other components, such as, for example ResourceConfigId.

The process 400 may send (at block 430) an acknowledgement to the network node. The process 400 may then end.

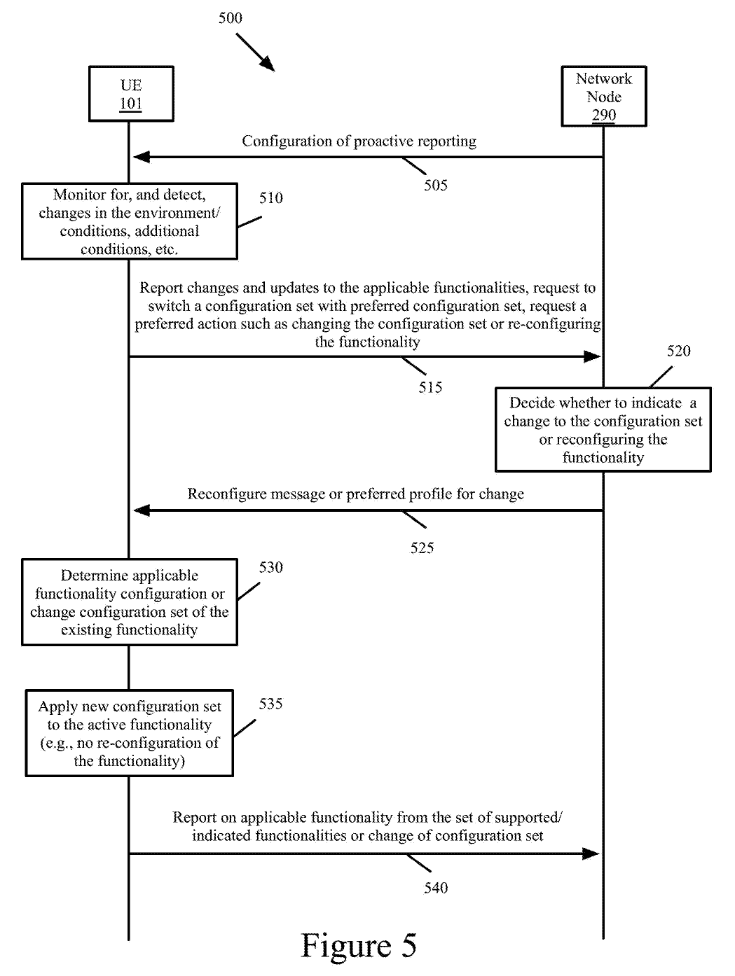

FIG. 5 is a sequence diagram 500 illustrating an example message flow of the AI/ML enabled functionality configuration considering a UE-sided model and a proactive reporting, according to an example implementation of the present disclosure. The network node 290 may send a UECapabilityEnqiry message to initiate the procedure for the UE 101 to report its AI/ML supported functionalities. The UE 101 may send a UECapablityInformation message to the network node 290, containing supported functionalities at the UE side.

The network node 290 may conFIGURE(at block 505) the UE 101 that the UE is allowed to provide its applicable functionalities. In addition, the network node 290 may configure the UE 101 to report a preferred set and send change configuration set request if the additional conditions change (e.g., based on preconfigured triggers/conditions). The network node 290 may configure the UE 101 in step 505 by, for example, using RRC signaling after establishment of an RRC connection between the network node and the UE 101.

In some embodiments, the UE 101 may also request the network node 290 if it needs to change configuration sets or request to fully re-configure the functionality. This may be indicated by the UE 101 with or without the cause. The UE 101 may also indicate its preferred action (e.g., change the configuration set or functionality reconfiguration) and/or preferred configuration set. In some embodiments, the UE 101 or the network node 290 may change the configured sets irrespective of whether the additional conditions/environment or applicability of a given functionality changes.

The following discussion uses a first assumption that the network node 505 has configured the UE 101 for proactive reporting. In proactive reporting, the network node 290 decides to switch or change the functionality configuration set.

The UE 101, in block 510, may monitor the additional conditions and may detect any changes in the environment conditions. The environment may be the UE’s environment, urban macro, rural, mobility, weather conditions, etc. The additional conditions may be the UE-side or the network side additional conditions, as described above.

The UE 101, in step 515, may report the applicable functionalities to the network node 290 upon a change of the applicable functionality or conditions. In addition, the UE 101 may request a change (or switch) of a configuration set with a preferred configuration set or request a preferred action such as changing the configuration set or fully re-configuring the functionality. The UE 101 may use, for example, a signal such as UAI, DCI, MAC CE, or RRC to send the report to the network node 290.

In block 520, the network node 290 may decide whether to indicate a change to the configuration set or reconfiguring of the functionality. The network node 290 may send (at step 525) inference configuration for the applicable functionality(s) to the UE 101 or change configuration set indication to apply the configuration set without completely reconfiguring the functionality.

The UE 101 may determine (at block 530) the applicable functionality configuration or may change the configuration set of the existing functionality. The UE 101 may apply (at block 535) the new configuration set indicated by the network node 290 to the active functionality (e.g., without re-configuration of the functionality). The UE 101 may apply the new configuration, for example, as described in block 425 of FIG. 4. The UE 101 may then start inference and monitoring based on the network node or the UE activation and deactivation. The UE 101 may indicate (at step 540) to the network node 290, for example, with an RRC complete like message, to indicate the new configuration set has been applied .

In some embodiments, a second assumption may be considered where the UE may select a configuration set, apply the selected configuration set, and indicate the changes to the network with or without cause.

In some embodiments, in case of reactive reporting, the RRCReconfiguration message may include both the associated ID(s) and the corresponding functionality configuration set(s) including inference configuration set (s) with an index to indicate the default configuration set or the preferred configuration set the UE shall apply. In these embodiments, the UE may perform the following action. The UE may receive all necessary information (e.g., the associated ID and functionality and inference configuration set(s)) in a single message. The UE may immediately perform inference for that functionalities that are identified as applicable based on the received configuration.

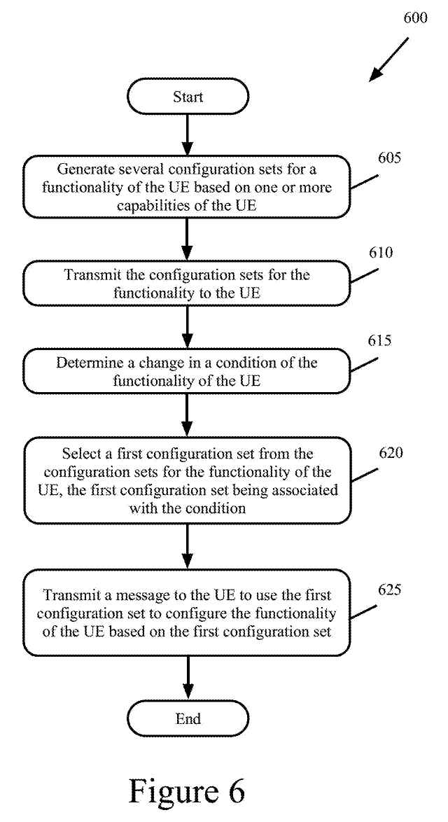

FIG. 6 is a flowchart illustrating an example method/process 600 performed by a network node for configuring a functionality to a UE, according to an example implementation of the present disclosure. With reference to FIG. 6, the process 600 may be performed by at least one processor of a network node, such as the BS 103, shown in FIG. 1 or any other RAN node, LMF node, or the core network node.

The process 600 may generate (at block 605) several configuration sets for a functionality of the UE based on one or more capabilities of the UE. The functionality may be an AI/ML functionality that the UE is ready to apply for AI/ML model inference or an AI/ML functionality that the UE supports based on the UE capabilities. The functionality may be, for example, an AI/ML-enabled functionality associated with CSI estimation, CSI reporting, beam management, positioning, or mobility.

The process 600 may also consider additional conditions either on the UE side or the network node side of the network to generate the configuration sets for the functionality. For example, the network node 290 and the UE 101 may exchange the UE capabilities as shown in step 210 in FIG. 2. The network node 290 may send the network side additional conditions to the UE as shown in step 215 of FIG. 2. The UE may send the UE side additional conditions to the network node as shown in step 220 of FIG. 2.

The process 600 may transmit (at block 610) the configuration sets for the functionality to the UE. The process 600, in some embodiments, may transmit the configuration sets for the functionality in an RRC message. The configuration sets may include only full configuration sets, only partial configuration sets, or a mix of full and partial configuration sets. A full configuration set may include parameters that allow the UE to perform tasks and reporting for the functionality corresponding to the configuration set. A partial configuration set may include a subset of parameters of a corresponding full configuration set that may allow the UE to determine whether the functionality corresponding to the configuration set is a functionality the UE is ready to apply to the AI/ML model (e.g., the functionality is an applicable functionality). Configuring a configuration set to the UE may enable the UE to perform AI/ML inference.

The network node, in some embodiments, may receive a message from the UE indicating that the functionality corresponding to a partial configuration set is a functionality that the UE is ready to apply to the AI/ML model (e.g., the functionality is an applicable functionality). The network node may then transmit the full configuration sets corresponding to the partial configuration set to the UE. At least some of the configuration sets may include one or more AI/ML functionality model LCM parameters and one or more legacy functionality specific parameters.

The process 600 may determine (at block 615) a change in a condition of the functionality of the UE. For example, the network node 290 may determine a change in the network node side of the wireless communication network. The network node 290 may also receive a message from the UE indicating a change in a UE side of the wireless communication network.

The process 600 may select (at block 620) a first configuration set from the configuration sets for the functionality of the UE. The first configuration set may be associated with the changed condition. The process 600 may transmit (at block 625) a message to the UE to use the first configuration set to configure the functionality of the UE based on the first configuration set. For example, the process 600 may transmit the unique ID of the first configuration set to the UE. In some embodiments, the message may be transmitted to the UE by a UAI, DCI, or MAC CE. The process 600 may then end.

In some embodiments, each configuration set may be associated with a unique ID (e.g., a unique index) which the process 600 may transmit to the UE. In the embodiments that the UE is configured for proactive reporting, the process 600 may transmit the unique IDs to the UE in a first RRC message. After determining the change in the condition of the functionality of the UE, the process 600 may transmit the configuration sets for the functionality to the UE in a second RRC message.

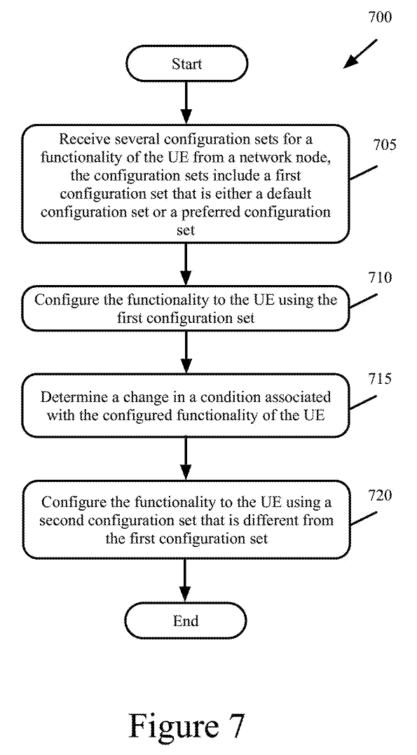

FIG. 7 is a flowchart illustrating an example method/process 700 performed by a UE for configuring a functionality to the UE, according to an example implementation of the present disclosure. With reference to FIG. 7, the process 700 may be performed by at least one processor of a UE 101A-101C, shown in FIG. 1.

The process 700 may receive (at block 705) several configuration sets for the functionality of the UE from a network node. The network node may, for example, be the BS 103, shown in FIG. 1 or any other RAN node, LMF node, or the core network node. The functionality, in some embodiments, may be an AI/ML-enabled functionality associated with one of CSI estimation, CSI reporting, beam management, positioning, or mobility.

The configuration sets, in some embodiments, may be either data collection configuration sets, inference configuration sets, or monitoring configuration sets. The configuration sets may include a first configuration set that is either a default configuration set or a preferred configuration set. A default configuration set may include one or more preset parameter values that the UE may apply when the network node has not specified an alternative. A preferred configuration set may include one or more parameter values that the network node or the UE has determined as desirable. The functionality may be an AI/ML functionality that the UE is ready to apply for AI/ML model inference (e.g., the functionality is an applicable functionality) or an AI/ML functionality that the UE supports based on the UE capabilities.

The process 700 may configure(at block 710) the functionality to the UE using the first configuration set. The process 700, in some embodiments, may receive the configuration sets for the functionality and several IDs associated with the configuration sets from the network node in an RRC message. The process 700 may configure the functionality of the UE by using the first configuration set after receiving the RRC message. The process 700 may perform inference after configuring the functionality to the UE using the first configuration set.

The process 700, in some embodiments, may receive several IDs (e.g., several indexes) from the network node in a first RRC message. Each ID may be associated with a corresponding configuration set. The process 700 may identify potential functionalities based on the IDs. The process 700 may receive the configuration sets for the functionality in a second RRC message. The process 700 may configure the functionality of the UE by using the first configuration set after receiving the second RRC message. The process 700 may then perform inference after configuring the functionality to the UE using the first configuration set.

The process 700 may determine (at block 715) a change in a condition associated with the configured functionality of the UE. For example, the UE may report the change to the network node. The UE may request to use a configuration set that is preferred by the UE for configuring the functionality to the UE and/or the UE may identify one or more configuration sets that are not suitable to the UE.

The process 700 may configure(at block 720) the functionality to the UE using a second configuration set. The second configuration set may be different from the first configuration set. A least one of the first and second configuration sets, in some embodiments, may include one or more AI/ML functionality model parameters and one or more legacy functionality specific parameters.

The UE may receive the identification associated with the second configuration set from the network node. For example, the UE may receive the identification associated with the second configuration set from the network node in one a UAI, DCI, or MAC CE. The UE may then configure the functionality to the UE by using the second configuration set after receiving the identification.

The process 700, in some embodiments, may identify the second configuration set without communicating with the network node and may transmit a message to the network node indicating that the UE has configured the functionality using the second configuration set. The process 700, in some embodiments, may identify the second configuration set based on an association between the second configuration set and the change in the condition.

The process 700, in some embodiments, may transmit a successful indication message to the network node after configuring the functionality to the UE using a second configuration set. The process 700, in some embodiments, may determine a change in another condition associated with the configured functionality of the UE. The process 700, in response to determining the change in the other condition, may transmit a request to the network node to fully reconfigure the functionality. The process 700 may then end.

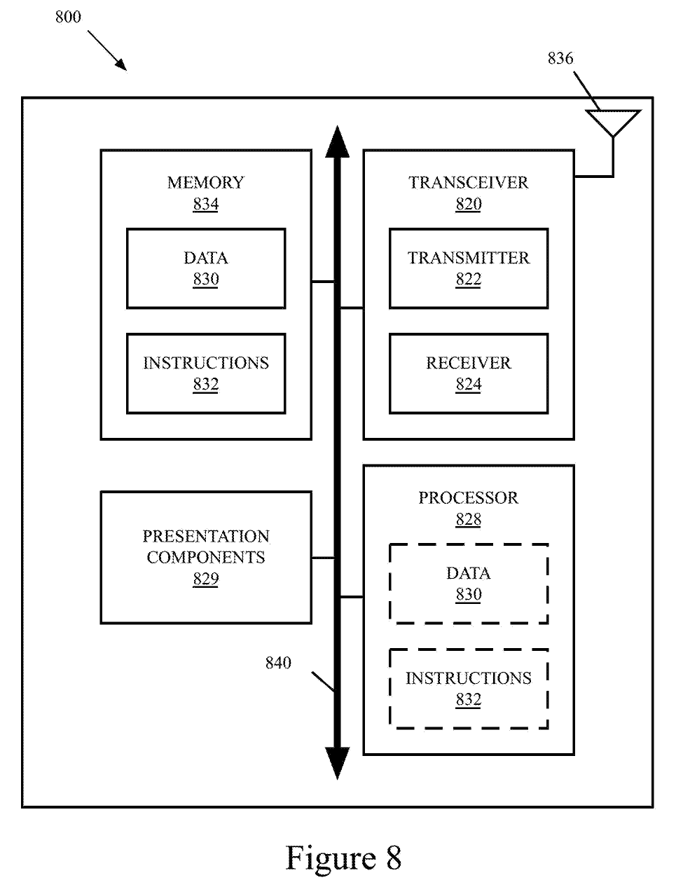

FIG. 8 is a block diagram illustrating a node 800 for wireless communication, according to an example implementation of the present disclosure. As illustrated in FIG. 8, a node 800 may include a transceiver 820, a processor 828, a memory834, one or more presentation components 829, and at least one antenna 836. The node 800 may also include a radio frequency (RF) spectrum band module, a BS communications module, a network communications module, and a system communications management module, Input / Output (I/O) ports, I/O components, and a power supply (not illustrated in FIG. 8).

Each of the components may directly or indirectly communicate with each other over one or more buses 840. The node 800 may be a UE, a BS, or any other network node that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including, but not limited to, usable, non-usable, and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable instructions 832 (e.g., software codes) that are configured to, when executed, cause the processor 828 to perform various functions disclosed herein, for example, with reference to FIGS. 1 through 3. Alternatively, the instructions 832 may not be directly executable by the processor 828 but may be configured to cause the node 800 (e.g., when compiled and executed) to perform various functions disclosed herein.

The processor 828 (e.g., having processing circuitry) may include an intelligent hardware device, e.g., a Central Processing Unit (CPU), a microcontroller, an ASIC, etc. The processor 828 may include memory. The processor 828 may process the data 830 and the instructions 832 received from the memory 834, and information transmitted and received via the transceiver 820, the baseband communications module, and/or the network communications module. The processor 828 may also process information to send to the transceiver 820 for transmission via the antenna 836 to the network communications module for transmission to a CN.

One or more presentation components 829 may present data indications to a person or another device. Examples of presentation components 829 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the "computer system" mentioned here refers to a computer system built into the terminal device or the BS, and the computer system includes an OS and hardware components such as a peripheral device. Furthermore, the "computer-readable recording medium" refers to a portable medium such as a flexible disk, a magneto-optical disk, a ROM, a CD-ROM, and the like, and a storage device built into the computer system such as a hard disk.

Moreover, the "computer-readable recording medium" may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment can also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A wireless communication network node, comprising:
one or more non-transitory computer-readable media storing one or more computer-executable instructions for configuring a functionality to a user equipment (UE); and
at least one processor coupled to the one or more non-transitory computer-readable media, and configured to execute the one or more computer-executable instructions to cause the network node to:
generate a plurality of configuration sets for the functionality of the UE based on one or more capabilities of the UE;
transmit the plurality of configuration sets for the functionality to the UE;
determine a change in a condition of the functionality of the UE;
select a first configuration set in the plurality of configuration sets, which is associated with the condition, for the functionality of the UE; and
transmit a message to the UE to use the first configuration set to configure the functionality of the UE based on the first configuration set.

2. The network node of claim 1, wherein the functionality is one of an artificial intelligence/machine learning (AI/ML) functionality that the UE is ready to apply for AI/ML model inference or an AI/ML functionality that the UE supports based on the UE capabilities.

3. The network node of claim 1, wherein:
the plurality of configuration sets comprises a partial or initial configuration set comprising a subset of parameters of a corresponding full configuration set, the subset of parameters allowing the UE to determine whether the functionality corresponding to the configuration set is a functionality that the UE is ready to apply for an artificial intelligence/machine learning (AI/ML) model,
the at least one processor is further configured to execute the one or more computer-executable instructions to cause the network node to:
receive a message from the UE indicating that the functionality corresponding to the partial configuration set is a functionality that the UE is ready to apply to the AI/ML model, and
transmit the full configuration sets corresponding to the partial configuration set to the UE.

4. The network node of claim 1, wherein the plurality of configuration sets comprises only full configuration sets, only partial configuration sets, or a mix of full and partial configuration sets,
a full configuration set comprising parameters allowing the UE to perform tasks and reporting for the functionality corresponding to the configuration set,
a partial configuration set comprising a subset of parameters of a corresponding full configuration set allowing the UE to determine whether the functionality corresponding to the configuration set is a functionality that the UE is ready to apply to an intelligence/machine learning (AI/ML) model, and
wherein configuring a configuration set in the plurality of configuration sets to the UE enables the UE to perform AI/ML inference.

5. The network node of claim 1, wherein determining the change in the functionality of the UE comprises:
receiving a message from the UE indicating a change in a UE side of the wireless communication network.

6. The network node of claim 1, wherein determining the change in the functionality of the UE comprises:
determining a change, by the network node, in a network node side of the wireless communication network.

7. The network node of claim 1, wherein transmitting the plurality of configuration sets for the functionality to the UE comprises:
transmitting the plurality of configuration sets for the functionality and an identification (ID) associated with the functionality to the UE in a radio resource control (RRC) message.

8. The network node of claim 1, wherein:
each configuration set in the plurality of configuration sets is associated with a unique identification,
transmitting the message to the UE to use the first configuration set comprises:
transmitting the unique identification associated with the first configuration set to the UE.

9. The network node of claim 1, wherein transmitting the plurality of configuration sets for the functionality to the UE comprises:
transmitting a plurality of identifications (IDs) to the UE in a first radio resource control (RRC) message, each ID in the plurality of IDs associated with a corresponding configuration set in the plurality of configuration sets; and
after determining the change in the functionality of the UE, transmitting the plurality of configuration sets for the functionality to the UE in a second RRC message.

10. The network node of claim 9, wherein transmitting the message to the UE to use the first configuration set comprises:
transmitting an ID associated with the first configuration set to the UE.

11. The network node of claim 1, wherein transmitting the message to the UE comprises:
transmitting an ID associated with the first configuration set in one of UE assistance information (UAI), downlink control information (DCI), or medium access (MAC) control element (CE).

12. The network node of claim 1, wherein:
the network node is one of a base station (BS) or a location management function (LMF) server,
the plurality of configuration sets is one of data collection configuration sets, inference configuration sets, or monitoring configuration sets,
at least one of the plurality of configuration sets comprises one or more artificial intelligence/machine learning (AI/ML) functionality model life cycle management (LCM) parameters and one or more legacy functionality specific parameters, and
the functionality is an AI/ML-enabled functionality associated with one of channel state information (CSI) estimation, CSI reporting, beam management, positioning, or mobility.

13. The network node of claim 1,
wherein the at least one processor is further configured to execute the one or more computer-executable instructions to cause the network node to:
receive, from the UE, a message comprising one or more conditions in a UE side of the wireless communication network, and
wherein generating the plurality of configuration sets for the functionality for the UE comprises generating the plurality of configuration sets based on the one or more conditions in the UE side of the wireless communication network.

14. The network node of claim 1,
wherein the at least one processor is further configured to execute the one or more computer-executable instructions to cause the network node to:
determine one or more conditions in a network node side of the wireless communication network, and
wherein generating the plurality of configuration sets for the functionality for the UE comprises generating the plurality of configuration sets based on the one or more conditions in the network node side of the wireless communication network.

15. A method of configuring a functionality to a user equipment (UE) by a wireless communication network node, the method comprising:
generating a plurality of configuration sets for the functionality of the UE based on one or more capabilities of the UE;
transmitting the plurality of configuration sets for the functionality to the UE;
determining a change in a condition of the functionality of the UE;
selecting a first configuration set in the plurality of configuration sets, which is associated with the condition, for the functionality of the UE; and
transmitting a message to the UE to use the first configuration set to configure the functionality of the UE based on the first configuration set.
